(19) United States
(12) Patent Application Publication
(10) Pub. No.: US 2009/0043715 A1
(43) Pub. Date: Feb. 12, 2009

(54) Method to Continuously Diagnose and Model Changes of Real-Valued Streaming Variables

(75) Inventors: Wei Fan, New York, NY (US); Philip S. Yu, Chappaqua, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: International Business Machines Corporation, Armonk, NY (US)

(21) Appl. No.: 12/060,932

(22) Filed: Apr. 2, 2008

Related U.S. Application Data
(63) Continuation of application No. 11/405,233, filed on Apr. 17, 2006.

(51) Int. Cl. G06F 15/18

(52) U.S. Cl. 706/12

(57) ABSTRACT

The method trains an inductive model to output multiple models from the inductive model and trains an error correlation model to estimate an average output of predictions made by the multiple models. Then the method can determine an error estimation of each of the multiple models using the error correlation model.

### BACKGROUND OF THE INVENTION

### CROSS-REFERENCE TO RELATED APPLICATIONS

This application is a Continuation of U.S. application Ser. No. 11/405,233 filed Apr. 17, 2006, the complete disclosure of which, in its entirety, is herein incorporated by reference.

### STATEMENT OF GOVERNMENT INTEREST

This invention was made with government support under contract number H98230-04-3-001 awarded by the U.S. Department of Defense. The government has certain rights in this invention.

### FIELD OF THE INVENTION

The invention generally relates to methods of diagnosing prediction model changes.

### DESCRIPTION OF THE RELATED ART

One major dilemma for most modeling techniques is that the error of the model on unseen data is not known unless the truth about the data is revealed. For a target function t=F(x) where t is either continuous or drawn from a finite set of values, given a training set of size n, {(x1, t1), . . . , (xn, tn))}, an inductive learner produces a model y=f(x) to approximate the true function F(x). Usually, there exists a significant number of x such that y 6=t. In other words, the constructed model makes mistakes. In order to compare performance, a loss function is introduced. Given a loss function L(t, y) where t is the true label and y is the predicted label, the expected loss of a model is the average loss for all examples, weighted by their probability. Commonly adopted loss functions include 0-1 loss, cost-sensitive loss and MSE loss.

One problem with the above formulation is that the true value t has to be known in order to evaluate the loss. However, in reality, the true label t is rarely known immediately after classification. Otherwise, data mining will not be very useful. For example, in credit card fraud detection, the true label of most transactions, either fraud or nonfraud, is determined in two months after the card holder receives the monthly statement, and either disputes some unauthorized charges or approves all charges by default. In other words, the performance of a model being applied in real world applications is not immediately known under most circumstances. The formulation on loss is only useful in a lab environment where labeled data is collected, different methods are compared using cross-validation, and, most importantly, it is assumed that the future unseen data has the same pattern and distribution as the collected data.

The unavailability of true labels and consequently unknown error of a model have several very unpleasant practical consequences. In a streaming environment, the most important characteristic of data streams is the problem of concept drift. The imminent danger of concept change on a previously learned model is the possibility of increase in error “the underlying model has the same pattern and distribution as the training data” or “no concept change”. The traditional error formulation only discusses expected error on a population, but not on a particular example.

Continuous or real-values streaming variable prediction (as distinguished from class label prediction), such as CPU utilization, response time, wait-time, IV value, P-value, is an important component within System Analytics of stream mining applications. Existing approaches (linear, regression and RBF) have four major problems that make them inapplicable for stream mining applications. First, conventional systems assume that the data does not change in pattern where the model is being applied on. Second, by default, in conventional systems the constructed model cannot detect any example that may deviate in pattern from the training data. Third, the conventionally constructed model does not give a bound and confidence interval for the prediction, in other words, there is no Quality of Service guarantee for the prediction. Fourth, when new labeled data items are collected, there is no simple way in conventional systems to re-construct the model besides “global” model re-training. The following disclosure addresses all four of these issues.

### SUMMARY OF THE INVENTION

The following discloses a general framework of “error selection” based on a separate “error model” that independently estimates the error range of predictions made by an inductive model on a particular example without a true label. Thus, methods of diagnosing prediction model changes are presented below. The method trains an inductive model to output multiple models from the inductive model and trains an error correlation model to estimate an average output of predictions made by the multiple models. Then the method can determine an error estimation of each of the multiple models using the error correlation model.

When training the inductive model, the method collects labeled training data, applies a machine learning algorithm on the collected training data, and obtains the multiple models. When obtaining the multiple models, the method can construct an ensemble of models using random decision trees, random forest, banking, boosting, and/or meta-learning, etc.

The training of the error correlation model comprises obtaining a hold-out validation set, predicting target values for the validation set using the multiple models, producing an average of the target values, determining errors of the target values, forming a new training set based on the target values, the average of the target values, and the errors of the target values, applying a regression algorithm on the new training set, and estimating an error of the average of the target values.

When determining the error estimation, the method supplies a streaming example to the multiple models, makes predictions with each of the multiple models using the streaming example, produces an average of the predictions, develops a new feature vector based on the predictions and the average of the predictions, and estimates an error of the average of the predictions.

In other words, the method trains multiple uncorrelated regression models (the multiple uncorrelated regression models are related to a master model). The method averages the output of the uncorrelated regression models to produce a median output and computes standard deviations of each uncorrelated regression model from the median output. Then the method can apply Gaussian distributions to the standard deviations to compute error interval and error bound for each uncorrelated regression model.

The method can create the multiple uncorrelated regression models from the master model by randomizing the master model, computing multiple bootstrap samples from the master model, and/or choosing a random subset of features of the master model.

The method reports outputs from the uncorrelated regression models whose value falls outside the error bound. By monitoring the amount of outputs of the uncorrelated regression models that have values that fall outside the error bound, the method can report when the testing data is undergoing significant pattern change, such as when the amount of outputs that fall outside the error bound exceeds a predetermined value. Further, this allows the method to update one or more of the uncorrelated regression models based on values being output by the uncorrelated regression models and/or to retrain the uncorrelated regression models that continue to produce outputs outside the predetermined range.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram showing training used to create multiple uncorrelated models;

FIG. 2 is a schematic diagram showing training used to create an error estimating model;

FIG. 3 is a schematic diagram showing using an error estimating model to predict a range of errors;

FIG. 4 is a schematic diagram showing a decision tree; and

FIG. 5 is a hardware diagram for implementing the present embodiments.

### DETAILED DESCRIPTION OF EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

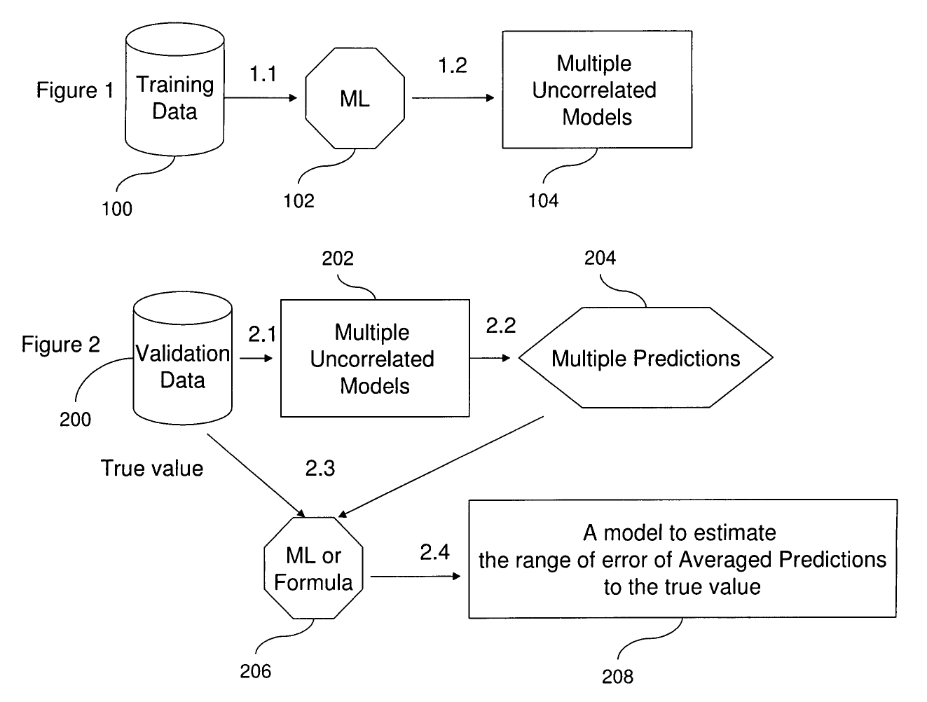

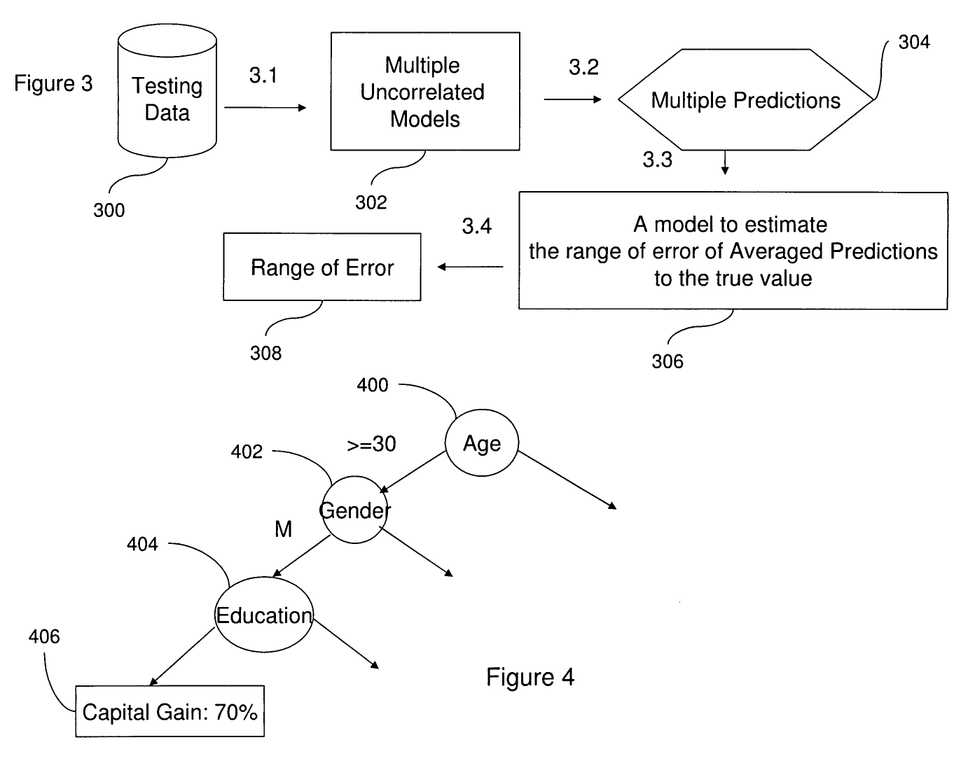

FIGS. 1-3 illustrate one aspect of the invention. More specifically, the figures illustrate methods of diagnosing prediction model changes. The method trains an inductive model to output multiple models from the inductive model (FIG. 1) and trains an error correlation model to estimate an average output of predictions made by the multiple models (FIG. 2). Then the method can determine an error estimation of each of the multiple models using the error correlation model (FIG. 3).

The method disclosed herein trains multiple uncorrelated regression models (there is no limitation on the model). The continuous output of multiple models are averaged as the final median output. Standard deviations will be computed from the median and each constituent model's prediction. Since each model is independently trained and uncorrelated, Gaussian distribution can be applied to compute both the error interval and bound.

For example, one output can be 50 secs with 5 sec error bound with 97% confidence. When there is no significant change in the pattern of the testing data, the true value of the prediction should fall with the error bound 97% of time. Otherwise, the data must have changed and the model must have been out of date. The method disclosed herein is not limited to one algorithm. Indeed, the basic idea is applicable to an almost unlimited number and type of algorithms.

Some of the motivation for the method disclosed herein is that under the streaming environment, patterns change over time, and during prediction, the true value is not available. Further, real time error estimation without true value is important for the validity of models, to change detection, and to provide model updates. The methods disclosed herein provide real-time error estimation without the true value.

When training the inductive model in FIG. 1, the method collects labeled training data in item 100, applies a machine learning (ML) algorithm 102 on the collected training data (1.1), and obtains the multiple uncorrelated models or decision trees 104 (1.2). When obtaining the multiple models, the method can constructing an ensemble of models using random decision trees, random forest, banking, boosting, and/or meta-learning, etc.

Thus, as shown in FIG. 1, the three steps in the training process are to collect labeled training data 100, apply a machine learning algorithm on the collected training data 102, and obtain an ensemble of k models or multiple uncorrelated models 104. There are many ways to construct an ensemble of models. The invention is not limited to any particular ensemble techniques. A none-exhaustive list of existing ensemble techniques that are applicable includes randomdecision trees, randomforest, bagging, boosting, metalearning, etc.

The prediction output of each model (pi) of the ensemble is a continuous value. For classification problems where the target variable t is one of the discrete values, each model predicts the posterior probability for each example to belong to any one of these discrete values. In credit card fraud detection, each model predicts P(fraud|x) and P(fraud|x)ε[0, 1]. For modeling techniques that cannot directly output probabilities, the simplest solution is to assign a value of 1 to the predicted label and 0 to all other none-predicted labels, such as P(fraud|x)=1 and P(normal|x)=0.

For regression problems where the target variable t is a continuous variable, for example, age and income, the prediction output by regression algorithms is continuous by definition. The final prediction output by ensemble of model is the average of the output from each model inside the ensemble or p_{avg}=Ppi k.

The training of the error correlation model in FIG. 2 comprises obtaining a hold-out validation set 200 and, in items 2.1 and 2.2, predicting target values 204 for the validation set using the multiple models 202. The machine learning or a formula 206 is used (2.3) to produce an average of the target values, and determine errors of the target values. The machine learning 206 forms a new training set based on the target values, the average of the target values, and the errors of the target values. Finally, the machine learning 206 applies a regression algorithm on the new training set, and estimates an error of the average of the target values 208 (2.4).

A hold-out validation set is used to train an estimation model to estimate the average output of the predictions made by the ensemble of models obtained in FIG. 1. First, a hold-out validation set is obtained. It is a labeled dataset similar to the training obtained in FIG. 1. Then, the ensemble of models predicts the target value of the validation set. Next, the predictions of these ensembles, their average prediction, and the error of the prediction are concatenated and used to form a new training set of the following form: D={p1, p2, . . . , pk, P_{avg},|P_{avg}. t|}. Following this, the method applies any applicable regression algorithm on D. Thus, the method obtains a model that estimate the error of p_{avg}.

When determining the error estimation in FIG. 3, the method supplies a streaming example 300 to the multiple models 302 (3.1), makes predictions 304 with each of the multiple models using the streaming example (3.2). In item 306, a model produces an average of the predictions (3.3), develops a new feature vector based on the predictions and the average of the predictions, and estimates an error of the average of the predictions with respect to the true value, to produce the range of error 308 (3.4).

Thus, the embodiments herein use the error estimate model 306 in a streaming environment. Thus, a streaming example without a true label is given to the ensemble of k models 302. Each model makes a prediction 304 and their predictions are averaged. A new feature vector (p1, p2, . . . , pk, p_{avg}) is sent to the error estimate model 306. Finally, the error estimation model 306 makes a prediction of the error of the averaged prediction p_{avg}.

There are many ways to use the method disclosed herein. For example, one manner of use is with online detection of a change in the data's pattern and the model's “inability” to make a correct prediction. With real-time model adaptation and evolution to adjust to these changes, the model can efficiently evolve “example-by-example” with the methodology disclosed herein.

In one embodiment, the method is implemented based on regression tree algorithms, although one ordinarily skilled in the art would understand that the basic idea disclosed herein is applicable to a wide range of other choices, such as linear regression, RFT, RBF and Neural Network based approaches.

A regression tree is very similar to inductive decision trees and nodes of the tree are grouped with similar continuous variable values. An example of a regression tree is shown in FIG. 4 where those having an age 400 greater than or equal to 30 branch to a gender node 402, where males (M) branch to an education node 404, which eventually branches to a capital gain prediction 406. The capital gain value of 70% at 406 is calculated by averaging the capital gain of all training examples that are sorted into this node by the regression tree.

Regression tree algorithms are used in this example because regression analysis can handle both categorical and continuous variables, while other choices such as linear regression and RFT can only handle continuous variables. Further, regression analysis assumes no predefined shape or structure of the model to be constructed while both RBF and Neural Network based approaches assume a shape or structure of the function to be constructured which may become completely obsolete and far-fetched when the true function changes. Also, regression trees shatter the training data space into many subspaces, which allows model updates to be effectively done in each subspace without a global computation. This divide-conquer approach eliminates the need for quadratic global optimization, which makes the method very computationally efficient. In addition, the leaf node can either compute the average value or use a multiple linear regression model to fit over all continuous variables that optimize over local data. Finally, regression trees can be converted into comprehensible rules.

The multiple uncorrelated regression trees can be constructed in many ways. For example, for randomized regression trees, one feature can be chosen randomly. After this feature has been chosen, an optimal threshold is chosen to minimize the standard deviation of the two dividing branches. This picks any feature randomly, but also picks one dividing value to minimize the expected error.

Similarly, uncorrelated regression trees can be constructed by computing multiple bootstrap samples (e.g., 10-30 samples) and computing a regression tree from each individual bootstrap (this particular method would be limited to regression trees). Also, uncorrelated regression trees can be constructed by choosing a random subset of features, computing the standard deviation of each, and choosing the best one.

When the regression models are launched in stream mining applications, the following actions will take place. Examples whose true value falls outside of the prediction error bound range will be collected and reported to the system user. When there is a sufficient number of these examples (e.g., the percentage is more than 3% if the confidence interval is 97%) this signals that the testing data is undergoing significant pattern change. In situations where the true value is available immediately, the method updates the regression tree locally and immediately. If the updated regression trees still have more than the confidence interval failure rate, this may signal that a complete re-training is necessary.

One exemplary embodiment is based on Randomized Regression Decision Trees or RRDT. As mentioned above, with decision trees, input feature variables can be both continuous and categorical, there is no assumption about the shape of the true function F(x), the divide-conquer approach can be used in model construction, (so there is no quadratic global optimization cost), the model can output comprehensible rules, and model updates only involve local adaptations of the trees such as updating the leaf node.

When training the RRDT, this example picks a used feature randomly (a continuous feature can be used multiple times, while a categorical or discrete feature can be used only once in any given decision path starting from the root of the tree to the current node). For continuous features, this example chooses a random decision threshold θ, i.e., examples satisfying ≦θ go to the left branch, and examples satisfying >θ go to the right branch of the tree. For categorical features, examples with the same discrete values are grouped together and passed down to the same branch. The tree stops growing when one of the following condition holds true: (a) the height of tree exceeds some predefined limits, such as the total number of features (b) the number of example per leaf node is fewer than a predefined limit, such as 2, or (c) the target values of every example in the leaf node are a sufficiently close in their values.

Predicting with each RRDT is straightforward. The method follows the decision path of the tree according to the test condition at each node of tree. At the leaf node, the method predicts with the average target values of all training examples that fall into this leaf node. Updating RRDT is also straightforward. The method updates the average target value of the leaf node with the new labeled example.

The invention can take the form of an entirely hardware embodiment, an entirely software embodiment or an embodiment containing both hardware and software elements. In one embodiment, the invention is implemented in software, which includes but is not limited to firmware, resident software, microcode, etc.

Furthermore, the invention can take the form of a computer program product accessible from a computer-usable or computer-readable medium tangibly embodying program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk —read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

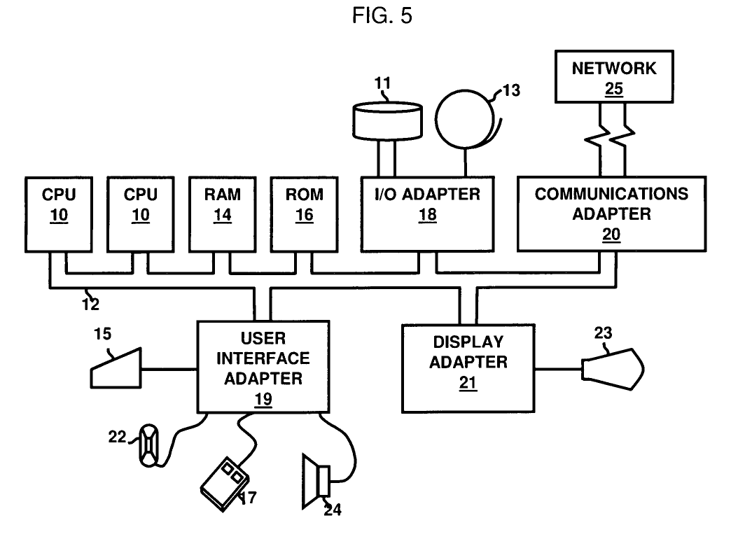

A representative hardware environment for practicing the embodiments of the invention is depicted in FIG. 5. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Thus, as shown above, the method disclosed herein trains multiple uncorrelated regression models (there is no limitation on the model). The continuous output of multiple models are averaged as the final median output. Standard deviations will be computed from the median and each constituent model's prediction. Since each model is independently trained and uncorrelated, Gaussian distribution can be applied to compute both the error interval and bound.

While the invention has been described in terms of preferred embodiments, those skilled in the art will recognize that the invention can be practiced with modification within the spirit and scope of the appended claims.

What is claimed is:

1. A method of diagnosing prediction model changes, said method comprising:
training an inductive model;
training an error correlation model to estimate an average output of predictions made by said inductive model; and
determining an error estimation of said inductive model using said error correlation model.

2. The method according to claim 1, all the limitations of which are incorporated herein by reference, wherein said training of said inductive model comprises:
collecting labeled training data;
applying a machine learning algorithm on said collected training data; and
obtaining said inductive model.

3. The method according to claim 2, all the limitations of which are incorporated herein by reference, wherein said obtaining of said inductive model comprises constructing an ensemble of models using one or more of random decision trees, random forest, banking, boosting, and meta-learning.

4. The method according to claim 1, all the limitations of which are incorporated herein by reference, wherein said training of said error correlation model comprises:
obtaining a hold-out validation set;
predicting target values for said validation set using said inductive model;
producing an average of said target values;
determining errors of said target values;
forming a new training set based on said target values, said average of said target values, and said errors of said target values;
applying a regression algorithm on said new training set; and
estimating an error of said average of said target values.

5. The method according to claim 1, all the limitations of which are incorporated herein by reference, wherein said determining of said error estimation comprises:
supplying a streaming example to said inductive model;
making predictions with said inductive model using said streaming example;
producing an average of said predictions;
developing a new feature vector based on said predictions and said average of said predictions; and
estimating an error of said average of said predictions.

6. A method of diagnosing prediction model changes, said method comprising:
training an inductive model to output multiple models from said inductive model;
training an error correlation model to estimate an average output of predictions made by said multiple models; and
determining an error estimation of each of said multiple models using said error correlation model.

7. The method according to claim 6, all the limitations of which are incorporated herein by reference, wherein said training of said inductive model comprises:
collecting labeled training data;
applying a machine learning algorithm on said collected training data; and
obtaining said multiple models.

8. The method according to claim 7, all the limitations of which are incorporated herein by reference, wherein said obtaining of said multiple models comprises constructing an ensemble of models using one or more of random decision trees, random forest, banking, boosting, and meta-learning.

9. The method according to claim 6, all the limitations of which are incorporated herein by reference, wherein said training of said error correlation model comprises:
obtaining a hold-out validation set;
predicting target values for said validation set using said multiple models;
producing an average of said target values;
determining errors of said target values;
forming a new training set based on said target values, said average of said target values, and said errors of said target values;
applying a regression algorithm on said new training set; and
estimating an error of said average of said target values.

10. The method according to claim 6, all the limitations of which are incorporated herein by reference, wherein said determining of said error estimation comprises:
supplying a streaming example to said multiple models;
making predictions with each of said multiple models using said streaming example;
producing an average of said predictions;
developing a new feature vector based on said predictions and said average of said predictions; and
estimating an error of said average of said predictions.

11. A method of diagnosing prediction model changes, said method comprising:
training an inductive model;
training an error correlation model to estimate an average output of predictions made by said inductive model; and
determining an error estimation of said inductive model using said error correlation model,
wherein said determining of said error estimation comprises:
supplying a streaming example to said inductive model;
making predictions with said inductive model using said streaming example;
producing an average of said predictions;
developing a new feature vector based on said predictions and said average of said predictions; and
estimating an error of said average of said predictions.

12. The method according to claim 11, all the limitations of which are incorporated herein by reference, wherein said training of said inductive model comprises:
collecting labeled training data;
applying a machine learning algorithm on said collected training data; and
obtaining said inductive model.

13. The method according to claim 12, all the limitations of which are incorporated herein by reference, wherein said obtaining of said inductive model comprises constructing an ensemble of models using one or more of random decision trees, random forest, banking, boosting, and meta-learning.

14. The method according to claim 11, all the limitations of which are incorporated herein by reference, wherein said training of said error correlation model comprises:
obtaining a hold-out validation set;
predicting target values for said validation set using said inductive model;
producing an average of said target values; and
determining errors of said target values.

15. The method according to claim 14, all the limitations of which are incorporated herein by reference, wherein said training of said error correlation model further comprises:
forming a new training set based on said target values, said average of said target values, and said errors of said target values;
applying a regression algorithm on said new training set; and
estimating an error of said average of said target values.

16. A method of diagnosing prediction model changes, said method comprising:
training an inductive model to output multiple randomized decision trees from said inductive model;
training an error correlation model to estimate an average output of predictions made by said multiple randomized decision trees; and
determining an error estimation of each of said multiple randomized decision trees using said error correlation model.

17. The method according to claim 16, all the limitations of which are incorporated herein by reference, wherein said training of said inductive model comprises:
collecting labeled training data;
applying a machine learning algorithm on said collected training data; and
obtaining said multiple randomized decision trees.

18. The method according to claim 17, all the limitations of which are incorporated herein by reference, wherein said obtaining of said multiple randomized decision trees comprises constructing an ensemble of models using one or more of random decision trees, random forest, banking, boosting, and meta-learning.

19. The method according to claim 16, all the limitations of which are incorporated herein by reference, wherein said training of said error correlation model comprises:
obtaining a hold-out validation set;
predicting target values for said validation set using said multiple randomized decision trees;
producing an average of said target values;
determining errors of said target values;
forming a new training set based on said target values, said average of said target values, and said errors of said target values;
applying a regression algorithm on said new training set; and
estimating an error of said average of said target values.

20. The method according to claim 16, all the limitations of which are incorporated herein by reference, wherein said determining of said error estimation comprises:
supplying a streaming example to said multiple randomized decision trees;
making predictions with each of said multiple randomized decision trees using said streaming example;
producing an average of said predictions;
developing a new feature vector based on said predictions and said average of said predictions; and
estimating an error of said average of said predictions.
